(19) United States
(12) Patent Application Publication
(10) Pub. No.: US 2006/0140224 A1
(43) Pub. Date: Jun. 29, 2006

(54) Generating a half rate/quarter rate flag stream for enhanced VSB decoder

(76) Inventors: William Yoshida, (US); Srinivasa Rao Gurusu, (US)

Correspondence Address: MCDERMOTT WILL & EMERY LLP, 600 13TH STREET, N.W., WASHINGTON, DC, 20005-3096, US

(21) Appl. No.: 11/020,581

(22) Filed: Dec. 27, 2004

(51) Int. Cl. H04J 3/04

(52) U.S. Cl. 370/535

(57) ABSTRACT

A system and method are provided for generating a flag stream that is used to mark the half rate and quarter rate bytes in an enhanced vestigial sideband (eVSB) data stream. The flag generator includes a buffer, a counter, and an interleaver. The buffer receives map data from a map decoder. The map data indicates the number of half rate and quarter rate packets that are present in a given eVSB data frame. The map data also includes a multiplexer option bit that indicates how the half rate and quarter rate packets are multiplexed in the eVSB data frame. The flag generator uses the map data to generate a flag stream that marks the bytes of the eVSB data frame for accurately separating the half rate data and the quarter rate data.

### TECNICAL FIELD

This invention relates generally to digital video systems, and more particularly, to processing of enhanced VSB data.

### BACKGROUND

Eight-level vestigial sideband (8-VSB) is a standard radio frequency (RF) modulation format adopted by the Advanced Television Systems Committee (ATSC) for the terrestrial transmission of digital television (DTV) to consumers in the United States and other adopting countries. In the U.S., 8-VSB is used to deliver a Moving Picture Experts Group (revision 2) transport stream (MPEG-2-TS) at a data rate of up to 19.39 Mbps in a 6 MHz channel.

In some environments, reception of the conventional 8-VSB format can be challenging. An enhanced VSB (eVSB or E8-VSB) format has been developed to address these issues. The eVSB system provides optional modes of operation that allow broadcasters to trade-off data rate for a lower carrier-to-noise threshold for some services. An eVSB signal includes additional forward error correction (FEC) coding layers that provide improved noise immunity and multipath performance. In general, services transmitted in the eVSB mode can be received under weaker signal conditions or greater channel impairments. Examples of applications for eVSB include delivery of “fall back” audio,programming services targeted at small DTV receivers with indoor antennas, non-real time transmissions of file-based information to handheld and pedestrian receivers, and robust data broadcasting to devices such as desktop and laptop computers.

FIG. 1 illustrates a conventional transport stream decoding system including an eVSB decoder. Data to signal the placement of enhanced data segments within the data field (“map data”) is typically transmitted during the data field sync segment. The payload of the enhanced data, comprised of half rate and quarter rate 164-byte packets to be transmitted in a VSB field, is specified by the eVSB map data and is constant for a group of sixteen VSB frames. In FIG. 1, a map decoder 105 receives transport stream 102 including eVSB packets. The map decoder 105 provides information about how the half rate and quarter rate bytes are interleaved to the postprocessor 115. The transport stream 102 is provided as input to the eVSB decoder 110. The eVSB decoder 110 segregates the main data (8-VSB data) from the eVSB data. The main data is provided as output. The eVSB data is provided to the postprocessor 115.

One problem with the decoding technique illustrated in FIG. 1 is that the postprocessor 115 cannot accurately decode the half rate and quarter rate streams based on only the map data. Although the map data provides information about how the half rate and quarter rate bytes are interleaved, this information is insufficient for the postprocessor 115 to de-expand the enhanced streams. There should be specific information for the each byte in the eVSB stream when the stream contains more than one enhanced stream. This information must be available for de-expander in sync with the enhanced stream in postprocessor 115 to de-expand the enhanced stream, otherwise enhanced streams are not decoded properly. Although the postprocessor 115 includes as output half rate and quarter rate streams, as one skilled in the art will appreciate, these outputs are illustrated because the function of the postprocessor 115 is to decode the enhanced stream and decode the half rate and quarter rate streams. This is generally the reverse process for the preprocessor (which is part of the eVSB encoder block) that expands the stream using a known HQ stream. This HQ stream is dropped at some point in the encoder (or transmitter) and is not transmitted along with the data to the receiver. Hence a receiver/decoder should have its own mechanism to decode the stream using MAP information provided by the encoder.

What is needed is a system and method for generating a flag stream to assist half rate/quarter rate content decoding.

### SUMMARY OF THE INVENTION

In one aspect, a system is provided for generating a flag stream. The system parses at least one of a half rate and a quarter rate stream from an eVSB data frame. The system includes a buffer, a counter, and an interleaver. The buffer is configured to receive map data from a map decoder, the map data indicating a multiplexer option bit, a number of half rate packets, and a number of quarter rate packets within the eVSB data frame. The counter is operatively coupled to the buffer and configured to hold the output of the buffer for a plurality of cycles. The interleaver is operatively coupled to the counter and configured to generate the flag stream by interleaving the counter output responsive to the multiplexer option bit.

In another aspect, a method is provided for generating a flag stream. The method receives, in a buffer, map data from a map decoder, the map data indicating a multiplexer option bit, a number of half rate packets, and a number of quarter rate packets within the eVSB data frame. The method counts the output of the buffer for a plurality of cycles, and interleaves the counter output to generate the flag stream responsive to the multiplexer option bit.

Further features of the invention, its nature and various advantages will be more apparent from the accompanying drawings and the following detailed description.

### BRIEF DESCRIPTION OF THE DRAWINGS

The accompanying drawings illustrate several embodiments of the invention and, together with the description, serve to explain the principles of the invention.

FIG. 1 illustrates a conventional transport stream decoding system including an eVSB decoder.

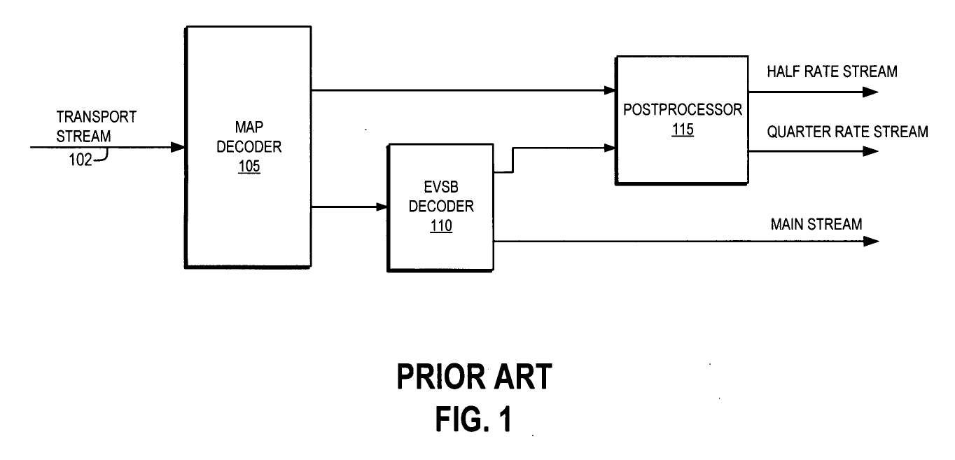

FIG. 2 is a block diagram illustrating a decoding system including a flag generator according to an embodiment of the present invention.

FIG. 3 is a block diagram illustrating further details of the flag generator.

FIG. 4 is a block diagram illustrating a decoding system including a flag generator according to another embodiment of the present invention.

### DETAILED DESCRIPTION OF THE EMBODIMENTS

The present invention is now described more fully with reference to the accompanying figures, in which several embodiments of the invention are shown. The present invention may be embodied in many different forms and should not be construed as limited to the embodiments set forth herein. Rather these embodiments are provided so that this disclosure will be thorough and complete and will fully convey the invention to those skilled in the art.

The present invention generates a half rate/quarter rate flag stream that is used to mark the half rate and quarter rate bytes in an eVSB stream. Each eVSB frame is comprised of 164 bytes of payload data, some of the bytes are associated with a half rate stream and some of the bytes are associated with a quarter rate stream. The map data provides information about the composition of the data frame. For ease of understanding the following description, the number of half rate packets is designed as Hn and the number of quarter rate packets is designed as Qm. An option bit specifies the multiplexing arrangement of half rate packets and quarter rate packets within the eVSB frame.

As one skilled in the art will appreciate, the eVSB system permits the transmitter (or encoder) to adjust dynamically the data rates of the main 8-VSB data and the corresponding half and quarter rate streams. Accordingly, the map data may change during decoding to reflect data rate or byte multiplexing changes.

Once the map data is available, an embodiment of the present invention generates a data stream that can be used to segregate or flag the bytes of the eVSB frame into half rate and quarter rate components. For ease of understanding the following description, a logic value of “1” is used to indicate a half rate byte and a logic value of “0” is used to indicate a quarter rate byte. Of course, these signal representations may be reversed or changed as one skilled in the art will appreciate.

For each eVSB frame to be processed, Hn number of half rate flags and Qm number of quarter rate flags are generated. These flags are multiplexed using the option bit setting. If the option bit has a logic value of “1”, then the Hn and Qn bytes are multiplexed as HQHQ. If the option bit has a logic value of “0”, then the Hn and Qm are multiplexed as HHH . . . QQQ.

Once the multiplexing is done, each bit from the multiplexer is written 184 times into the interleaver until the Hn+Qm bits are read from the multiplexer. Each bit is written 184 times because the postprocessor expects a 184 byte MPEG-2 packet. This is a requirement of the De-Interleaver (which is component of the postprocessor). The 184 byte packet is an enhanced MPEG-2 packet without a 4 byte header.

Interleaver output is the flag stream, which can be used to mark the bytes in the eVSB stream that is provided as input to the postprocessor. The postprocessor associates the first bit in the flag stream with the first byte of the eVSB stream. The second bit of the flag stream is then associated with the second byte of the eVSB stream, etc.

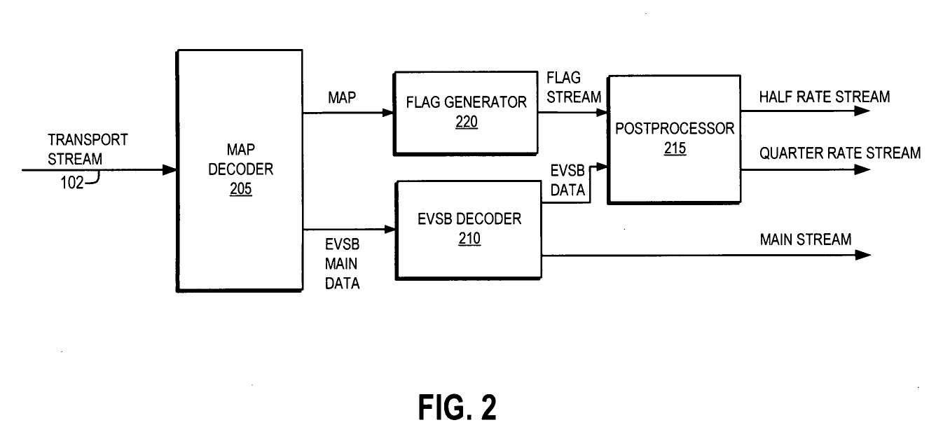

FIG. 2 is a block diagram illustrating a decoding system including a flag generator according to an embodiment of the present invention. The illustrated embodiment includes a map decoder 205, an eVSB decoder 210, a postprocessor 215, and a flag generator 220. The map decoder 205 receives as input a standards-compliant MPEG-2 transport stream 102. The map decoder 205 outputs map data and eVSB main data. The map data is provided as input to the flag generator 220. The eVSB main data is provided as input to the eVSB decoder 210. The eVSB decoder 210 segregates the eVSB stream from the main stream using conventional program identifiers (PIDs) or other techniques known to those skilled in the art.

The flag generator 220 receives the map data and generates an output flag stream. The flag stream is a sequence of bits that correspond with the multiplexed bytes of the eVSB data stream. That is, the map data indicates the number of half rate and quarter rate packets in each eVSB frame and how those packets are multiplexed. In one embodiment, the logic values (e.g., “1” and “0”) of the flag stream have a one-to-one correspondence with the bytes of the eVSB stream. The postprocessor 215 associates the first bit in the flag stream with the first byte of the eVSB stream. The second bit of the flag stream is then associated with the second byte of the eVSB stream, etc. Depending on the logic value of the flag stream bit, the postprocessor 215 can determine whether the corresponding byte is to be provided as output with the half rate stream or the quarter rate stream.

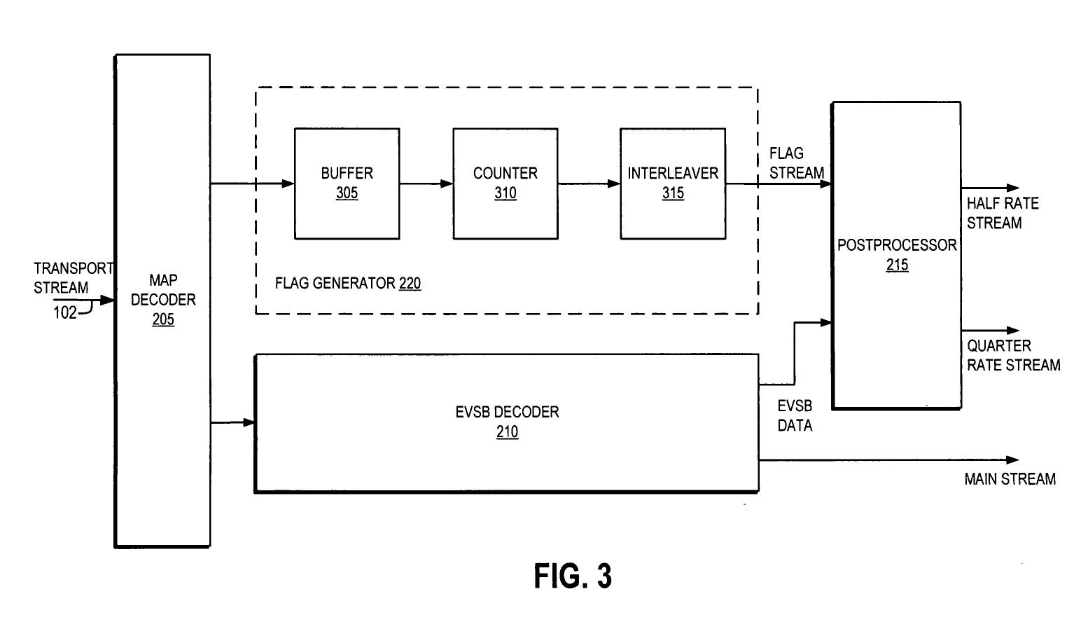

FIG. 3 is a block diagram illustrating further details of the flag generator. The flag generator 220 includes a buffer 305, a counter 310, and an interleaver 315. For each eVSB frame to be processed, Hn number of half rate flags and Qm number of quarter rate flags are generated. The buffer 305 represents a variable length buffer having a length of Qm+Hn. If the option bit has a logic value of “1”, then the Hn and Qn bytes are multiplexed as shown in Expressions 1-3.
For n>m: H1 Q1 H2 Q2 H3 Q3 . . . Hm Qm Hm+1 . . . Hn (1)
For m>n: H1 Q1 H2 Q2 H3 Q3 . . . Hn Qn Qn+1 . . . Qm (2)
For m=n: H1 Q1 H2 Q2 H3 Q3 . . . HnQm (3)

If the option bit has a logic value of “0”, then the Hn and Qm are multiplexed as shown in Expression 4.
H1 H2 H3 . . . Hn Q1 Q2 Q3 . . . Qm (4)

Once the buffer 305 has performed the multiplexing, the counter 310 writes each bit 184 times from the buffer 305 into the interleaver 315 until the Hn+Qm bits are read from the buffer 305.

The interleaver 315 represents a conventional cross-interleaver with a depth of ⅙ delay. Each buffer in the interleaver has a memory of n*M. The first buffer in the interleaver 315 has (1−1)*4=0 delay and, therefore, outputs the same input data immediately. The second buffer has (2−1)*4=4 delay. Therefore, the second buffer starts producing valid output from cycle 5, and the delay is more until the last buffer of the interleaver 315. The total delays associated with all the buffers are B*(B−1)*4/2=4140 bits.

To produce the flag stream output, the interleaver 315 expands each bit of the half rate flag two times and each bit of the quarter rate flag four times. This is done to correspond with the additional FEC coding present in the half rate and quarter rate streams. Although the map data provides information about how many quarter rate and half rate packets are present in the eVSB frame, it does not directly specify how many bytes of the 164 byte frame are used by each of the stream types. This information is derived by the flag generator 220.

The output of the interleaver 315 is the flag stream, which marks the bytes in the eVSB stream that is provided as input to the postprocessor 215. The postprocessor 215 generates the half rate and quarter rate output streams by associating the first bit in the flag stream with the first byte of the eVSB stream. The second bit of the flag stream is then associated with the second byte of the eVSB stream, etc.

As one skilled in the art will appreciate, the flag stream and the eVSB data stream are synchronized at the input of the postprocessor 215. More specifically, the bits of the flag stream corresponds with specific bytes of the eVSB data stream, so the arrival times need to be synchronized to ensure accurate stream separation.

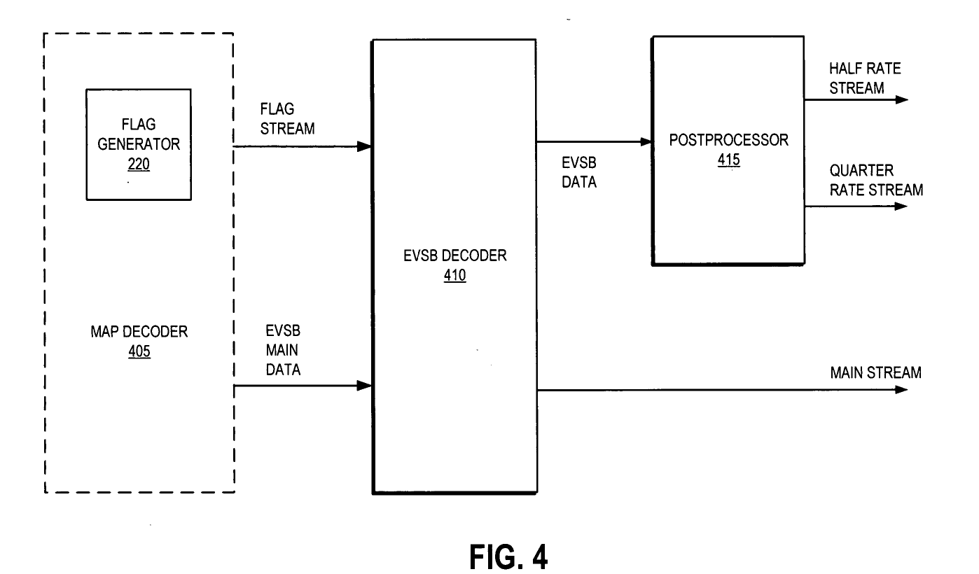

As one skilled in the art will appreciate, the foregoing functionality of the flag generator 220 can be implemented in various ways and the implemented functionality can be placed in various functional blocks. For example, FIG. 4 is a block diagram illustrating a decoding system including a flag generator according to another embodiment of the present invention. In FIG. 4, a map decoder 405 includes the above-described functionality of the flag generator 220. That is, the map decoder 405 implements the flag stream generation, and provides the flag stream and the eVSB data stream to the eVSB decoder 410. One advantage to this configuration, is the data and flag stream are more easily synchronized.

Having described embodiments of generating a half rate/quarter rate flag stream for enhanced vsb decoder (which are intended to be illustrative and not limiting), it is noted that modifications and variations can be made by persons skilled in the art in light of the above teachings. It is therefore to be understood that changes may be made in the particular embodiments of the invention disclosed that are within the scope and spirit of the invention as defined by the appended claims and equivalents.

What is claimed is:

1. A system for generating a flag stream for parsing at least one of a half rate and a quarter rate stream from an eVSB data frame, the system comprising:
a buffer configured to receive map data from a map decoder, the map data indicating a multiplexer option bit, a number of half rate packets, and a number of quarter rate packets within the eVSB data frame;
a counter operatively coupled to the buffer and configured to hold the output of the buffer for a plurality of cycles; and
an interleaver operatively coupled to the counter and configured to generate the flag stream by interleaving the counter output responsive to the multiplexer option bit.

2. The system of claim 1, wherein in the interleaver is further configured to expand each half rate byte marker to two bytes and to expand each quarter rate byte marker to four bytes.

3. The system of claim 1, wherein the interleaver comprises a cross-interleaver having a depth of ⅙delay.

4. The system of claim 1, wherein the plurality of cycles comprises 184 cycles.

5. The system of claim 1, wherein a first state of the multiplexer option bit directs the interleaver to interleave the flag stream in a pattern selected from the group consisting of: H1 Q1 H2 Q2 H3 Q3 . . . Hm Qm Hm+1 . . . Hn; H1 Q1 H2 Q2 H3 Q3 . . . Hn Qn Qn+1 . . . Qm; and H1 Q1 H2 Q2 H3 Q3 . . . HnQm.

6. The system of claim 1, wherein a second state of the multiplexer option bit directs the interleaver to interleave the flag stream in a pattern of H1 H2 H3 . . . Hn Q1 Q2 Q3 . . . Qm.

7. The system of claim 1, further comprising:
an eVSB decoder configured to receive a transport stream and to parse the transport stream into a plurality of eVSB data frames and a plurality of main data frames.

8. The system of claim 7, further comprising:
a postprocessor operatively coupled to the eVSB decoder and the flag generator, the postprocessor configured to generate a half rate stream and a quarter rate stream using the bits of the flag stream as markers of the bytes of the plurality of eVSB data frames.

9. A method for generating a flag stream for parsing at least one of a half rate and a quarter rate stream from an eVSB data frame, the method comprising:
receiving, in a buffer, map data from a map decoder, the map data indicating a multiplexer option bit, a number of half rate packets, and a number of quarter rate packets within the eVSB data frame;
counting the output of the buffer for a plurality of cycles; and
interleaving the counter output to generate the flag stream responsive to the multiplexer option bit.

10. The method of claim 9, further comprising:
expanding each half rate byte marker to two bytes and to expand each quarter rate byte marker to four bytes.

11. The method of claim 9, wherein the plurality of cycles comprises 184 cycles.

12. The method of claim 9, wherein the interleaving is performed by a cross-interleaver having a depth of ⅙delay.

13. The method of claim 9, wherein a first state of the multiplexer option bit interleaves the flag stream in a pattern selected from the group consisting of: H1 Q1 H2 Q2 H3 Q3 . . . Hm Qm Hm+1 . . . Hn; H1 Q1 H2 Q2 H3 Q3 . . . Hn Qn Qn+1 . . . Qm; and H1 Q1 H2 Q2 H3 Q3 . . . HnQm.

14. The method of claim 9, wherein a second state of the multiplexer option bit interleaves the flag stream in a pattern of H1 H2 H3 . . . Hn Q1 Q2 Q3 . . . Qm.

15. The method of claim 9, further comprising:
receiving, in an eVSB decoder, a transport stream and to parse the transport stream into a plurality of eVSB data frames and a plurality of main data frames.

16. The method of claim 15, further comprising:
generating a half rate stream and a quarter rate stream using the bits of the flag stream as markers of the bytes of the plurality of eVSB data frames.
